(19) United States
(12) Patent Application Publication
(10) Pub. No.: US 2004/0222668 A1
(43) Pub. Date: Nov. 11, 2004

(54) Structural design component for automotive vehicles

(76) Inventors: Peter Janevik, Goteborg (SE); Petter Horling, Goteborg (SE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/765,330

(22) Filed: Jan. 26, 2004

(30) Foreign Application Priority Data
Jan. 24, 2003 (EP) 03001640.6

(51) Int. Cl. B62D 25/00

(52) U.S. Cl. 296/187.03

(57) ABSTRACT

The present patent application relates to a hollow elongated structural design component (1) for automotive vehicles. The component (1) has a portion bendable when a collision load is applied in a longitudinal direction of the thereof, which portion has an initial closed cross-section essentially orthogonal to said longitudinal direction. The component (1) comprise means (2a) arranged to, during the initial stages of bending, essentially maintain the initial cross-section of said portion. A characterizing feature of the component is that it further comprise means (3) arranged to, during the initial stages of bending, induce local buckling at multiple distributed locations along a delimiting wall (1a) of said structural design component (1) arranged to, upon bending, being subject to negative pushing stresses. Hereby an increased energy absorption during bending collapse of the member (1) is provided for.

### TECHNICAL FIELD

The present patent application relates to a structural design component and in particular a structural design component for automotive vehicles having improved crash performance in accordance with the preamble of claim 1.

### BACKGROUND OF THE INVENTION

As design constraints of car structures and structural members are continuously made tougher, it is becoming increasingly difficult to design different structures, such as front and rear side rails and shotgun members, for optimum crash performance. The constraints often make it impossible to design for a buckling collapse of the structures, which is usually the optimal approach from a weight optimization perspective. Members having a pre-bent shape, for example, does normally not support a buckling deformation. As a result, bending collapse of the member becomes the only remaining option. However, this comes at a high price, as the energy absorption in a bending mode is rather ineffective per mass unit of structure as compared to buckling collapse. Several proposals have been made to increase the energy absorption in a bending mode.

One such device which is arranged to increase the energy absorption in a bending mode is previously known through U.S. Pat. No. 3,827,712, in which is described a structural frame capable of absorbing impact energy, which comprises a structural frame member of metallic material defining closed rectangular cross-section. Portion of each of the structural frame members is bent in the direction perpendicular to the longitudinal direction of the frame and energy absorption materials of metallic material with bowl-shaped projections are attached to those two opposing inner surfaces of the frame members which oppose in the direction of bending so that the bowl-shaped projections abut against each other. Upon collision, due to the resistance to plastic deformation of the bowl-shaped projections the shape of the cross-section of the structural frame may be maintained in its initial state and no abrupt decrease of bending moment takes place.

A disadvantage with the arrangement known from the prior art mentioned above is that it will increase the longitudinal bending resistance of the pre-bent structural frame member, why special consideration and reinforcement of the attachment points between the pre-bent structural frame member and the adjacent members will be required. This will usually result in an undesired overall weight increase.

### SUMMARY OF THE INVENTION

One object of the invention is to provide an improved structural design component and in particular an improved structural design component for automotive vehicles providing for increased energy absorption during bending collapse of the member addressing the problems described in relation to the prior art arrangement.

This object is achieved in accordance with the characterizing portion of claim 1.

Thanks to the provision of means for inducing local buckling at multiple locations along a delimiting wall of a structural design component being subject to negative pushing stresses during bending, which means does not contribute to the longitudinal stiffness of the structural design component in any significant amount, the energy absorption during bending collapse of the structural design component can be increased while at the same time the peak force level can be essentially maintained, such that no special consideration and reinforcement of the attachment points between the structural design component and the adjacent members will be required. Thus, energy absorption will be increased without any significant weight increase.

Preferred embodiments are listed in the dependent claims.

### DESCRIPTION OF DRAWINGS

In the following, the invention will be described in greater detail with reference to attached drawings, in which:

FIG. 1 is a simplified side view of a structural design component in the shape of a elongated hollow sheet metal beam not incorporating the invention,

FIG. 2 is a schematic illustration of the typical force characteristic over displacement for the case illustrated in FIG. 1,

FIG. 3 is a simplified side view of a structural design component in the shape of a elongated hollow sheet metal beam incorporating the invention,

FIG. 4 is a schematic illustration of the typical force characteristic over displacement for the case illustrated in FIG. 3,

FIG. 5 is a structural design component comprising a deformation control element in accordance with a preferred embodiment of the present invention.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DESCRIPTION OF EMBODIMENTS

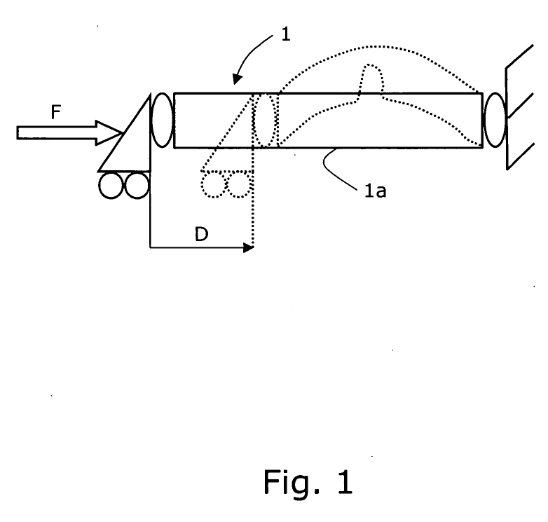

A simplified side view of a structural design component in the shape of a elongated hollow sheet metal beam 1 not incorporating the invention is shown in FIG. 1. Full lines illustrates the beam 1 prior to being subject to a bending collapse mode and the dotted lines illustrates the beam 1 being subject to a bending collapse mode.

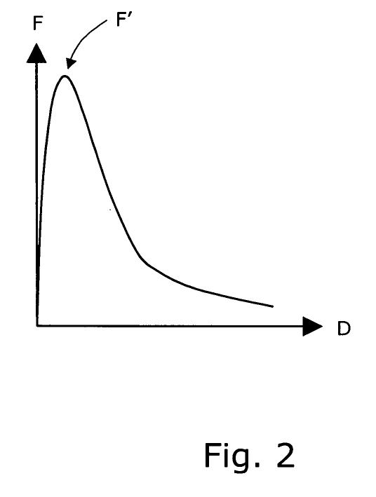

FIG. 2 shows the typical force F characteristic over displacement D for the case illustrated in FIG. 1. During the initial force buildup, the force will increase rapidly and linearly as the displacement progresses. The peak force F′ is basically a factor of the geometry through the section bending stiffness, the length of the beam 1 and the modulus of the material.

Once the peak F′ force is reached, a global bending buckling mode Is developed, in this case corresponding to the second Euler case. The force F then drops rapidly due to localized buckling developing on the side of the beam 1 having negative (pushing) stresses.

The local buckling coupled with the advent of bending moments in the beam 1 results in a loss of section in the beam 1 combined with an increase in stress levels due to the bending moments. The net effect is a very rapid loss of force carrying ability when the displacement D is increased.

The force F eventually drops down to a residual level, this level being mainly a factor of the tensile stress of the material, the length and width of the beam 1 combined with the material thickness.

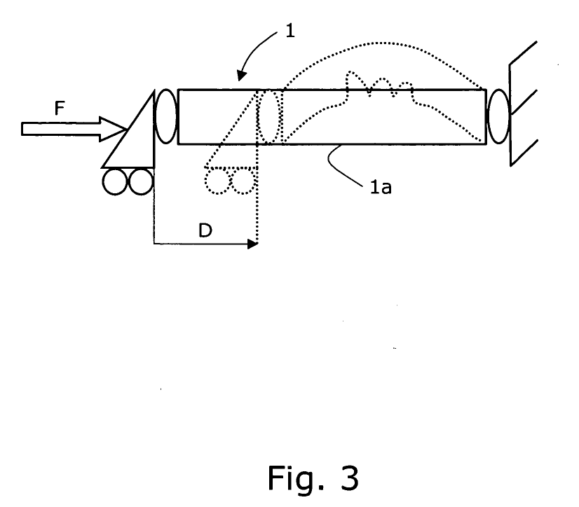

FIG. 3 illustrates a structural design component in the shape of a elongated hollow sheet metal beam 1 according to FIG. 1 incorporating a deformation control element (not shown) according to the invention. Full lines illustrates the beam 1 prior to being subject to a bending collapse mode and the dotted lines illustrates the beam 1 being subject to a bending collapse mode.

As illustrated in FIG. 3, the arrangement according to the invention results in the beam 1 buckling in multiple places in stead of one. The result is that there is an increased energy absorption during collapse.

The deformation in accordance with FIG. 3 is achieved through providing inside the beam 1 a deformation control element having means for keeping the cross-section thereof up at a certain level, although local buckling has started. Hereby the force level is kept up after buckling has been initiated. The deformation control element further has means for causing the beam 1 to develop local buckling in multiple places, whereby the energy absorption of the design is optimized.

By designing the deformation control element in such a way that it does not contribute to the beam 1 longitudinal stiffness in any significant amount, a preserved peak force level can be achieved. Hereby the need for special considerations and reinforcements of the attachment points between the beam and any surrounding structures can be eliminated.

The deformation control element can also be designed to be somewhat deformed during the final stages of the bending collapse, which will also contribute somewhat to the energy absorption of the design.

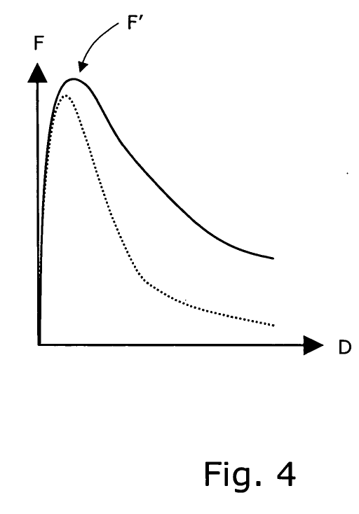

In FIG. 4 the typical force characteristic over displacement for the case illustrated in FIG. 3 is illustrated.

During the initial force buildup, the force will increase rapidly and linearly as the displacement progresses essentially corresponding to FIG. 2. As with the beam of FIG. 1, the peak force F′ is basically a factor of the geometry through the section bending stiffness, the length of the beam 1 and the modulus of the material.

Once the peak force F′ is reached, multiple bending buckling modes are developed. The force F then drops less rapidly as compared to FIG. 2, (also shown with dotted lines in FIG. 4), due to distributed buckling developing on the side of the beam 1 having negative (pushing) stresses.

The distributed buckling coupled with the presence of section maintaining means in the beam 1 results in a delayed loss of section in the beam 1. This results in a slower loss of force carrying ability when the displacement D is increased.

The force F eventually drops down to a residual level, this level being higher than that of the beam 1 in accordance with FIG. 1.

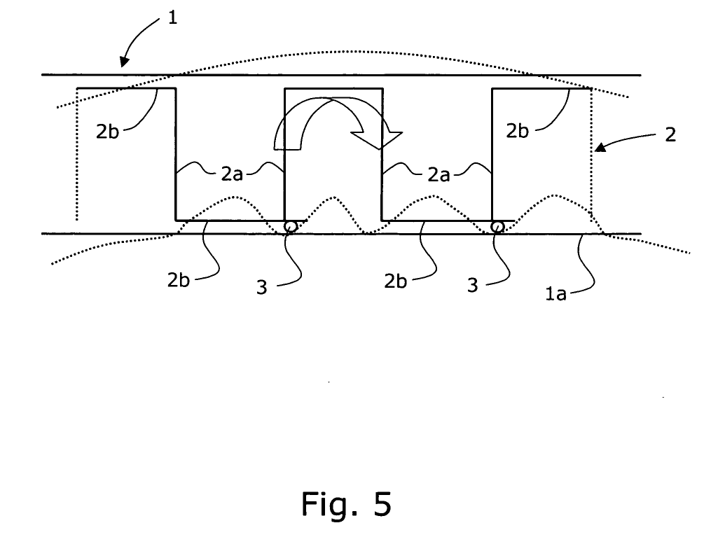

In FIG. 5 is illustrated a possible design of a structural design component 1 comprising a deformation control element 2 in accordance with a preferred embodiment of the present invention. The deformation control element 2 is illustrated in a cut through side view of the hollow sheet metal beam 1 of FIG. 3.

The beam 1 has a portion bendable when a collision load is applied in a longitudinal direction thereof. An initial closed cross-section of the beam 1 is essentially orthogonal to the longitudinal direction of the beam 1.

Inside the hollow sheet metal beam 1 is arranged the deformation control element 2, which provide means 2a arranged to, during the initial stages of bending, essentially maintain the initial cross-section of said bendable portion. These means 2a are here shown as part of the longitudinally extending deformation control element 2, and realized as multiple longitudinally spaced apart sheet members 2a arranged within said beam 1 essentially orthogonal to the longitudinal direction thereof and essentially filling out the initial closed cross-section thereof. These sheet members 2a are designed to keep the cross-section of the beam 1 up during the initial buckling.

The sheet members 2a are spaced apart by essentially longitudinally extending spacing sections 2b of low bending stiffness, also part of the deformation control element 2. Each of said spacing sections 2b interconnect two of said sheet members 2a along an inner delimiting wall of said beam 1. The spacing sections 2b alternatingly are arranged along opposing inner delimiting walls of said beam 1, in order to minimize any contribution to the bending stiffness thereof.

The deformation control element 2 further provide means 3 arranged to, during the initial stages of bending, induce local buckling at multiple distributed locations along a delimiting wall of said beam arranged to, upon bending, being subject to negative pushing stresses. This local buckling at multiple distributed locations during bending collapse is illustrated with dotted lines in FIG. 5.

The means 3 for inducing local buckling comprise longitudinally spaced apart interconnections 3 between said longitudinally extending deformation control element 2 and said delimiting wall of said beam 1, which wall is arranged to, upon bending, provide an inner radius of curvature of said portion being subject to negative pushing stresses. The deformation control element 2 is connected to the beam 1 at locations where the bending stiffness of the deformation control element 2 is low, here illustrated as portions of the spacing sections 2b projecting slightly past the sheet members 2a, thus the stiffness contribution to the beam 1 is kept to a minimum. These interconnections 3 can also be arranged between at least two of the sheet members 2a and the delimiting wall of the beam 1. Alternatively these interconnections 3 can be arranged between at least two of said spacing sections 2b and said delimiting wall of the beam 1.

The interconnections 3 further are arranged only at the side of the deformation control element 2 facing the side of the beam 1 intended to provide the inner radius of curvature during bending collapse, i.e. the side of the beam being subject to negative pushing stresses during bending. These interconnections 3 can be achieved in any suitable way, e.g. through welding, gluing or any other suitable method of interconnection known to the person skilled in the art. In the case of both the beam 1 and the deformation control element 2 being steel sheet metal structures, welding is usually the preferred method of interconnection.

The deformation control element 2 must be continuous throughout the distance where the bending radius is designed to appear to have the desired effect of causing multiple distributed bending buckling modes during bending.

The invention is not limited to the above-described embodiments, but may be varied within the scope of the following claims.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

Claims

1. A hollow elongated structural design component (1) for a vehicle body having a portion bendable when a collision load is applied in a longitudinal direction of the component (1), said portion having an initial closed cross-section essentially orthogonal to said longitudinal direction, said component (1) comprising means (2a) arranged to, during the initial stages of bending, essentially maintain the initial cross-section of said portion, characterized in, that said component (1) further comprise means (3) arranged to, during the initial stages of bending, induce local buckling at multiple distributed locations along a delimiting wall (la) of said structural design component (1) arranged to, upon bending, being subject to negative pushing stresses.

2. A structural design component (1) according to claim 1,
characterized in that said means (2a) for maintaining the initial cross-section and said means (3) for inducing local buckling are part of a longitudinally extending deformation control element (2) arranged within said component, which deformation control element (2) is continuous throughout said portion.

3. A structural design component (1) according to claim 1 or claim 2,
characterized in that said means for maintaining the initial cross-section comprise at least two longitudinally spaced apart sheet members (2a) arranged within said structural design component (1) essentially orthogonal to said longitudinal direction and essentially filling out the initial closed cross-section.

4. A structural design component (1) according to claim 3,
characterized in that said sheet members (2a) are spaced apart by essentially longitudinally extending spacing sections (2b) of low bending stiffness.

5. A structural design component (1) according claim 4,
characterized in that each of said spacing sections (2b) are arranged along an inner delimiting wall of said structural design component (1) and interconnect two of said sheet members (2a).

6. A structural design component (1) according to claim 5,
characterized in that said spacing sections (2b) alternatingly are arranged along opposing inner delimiting walls of said structural design component (1).

7. A structural design component (1) according to claim 2,
characterized in that said means for inducing local buckling comprise longitudinally spaced apart interconnections (3) between said deformation control element (2) and said delimiting wall (1a) of said structural design component (1) arranged to, upon bending, being subject to negative pushing stresses.

8. A structural design component (1) according to any of claims 3 to 6,
characterized in that said means for inducing local buckling comprise longitudinally spaced apart interconnections (3) between at least two of said sheet members (2a) and said delimiting wall (1a) of said structural design component (1) arranged to, upon bending, being subject to negative pushing stresses.

9. A structural design component (1) according to any of claims 4 to 6,
characterized in that said means for inducing local buckling comprise longitudinally spaced apart interconnections (3) between at least two of said spacing sections (2b) and said delimiting wall (1a) of said structural design component (1) arranged to, upon bending, being subject to negative pushing stresses.

10. A structural design component (1) according to any one of the preceding claims,
characterized in that said structural design component (1) is a sheet metal component and said means (2a) for maintaining the initial cross-section and said means (3) for inducing local buckling comprise sheet metal members.

11. A structural frame of a vehicle body,
characterized in that it comprises a structural design component (1) according to any one of the preceding claims.

12. A vehicle,
characterized in that it comprises a structural design component (1) according to any one of claims 1 to 10.

US Type claims

1. A hollow elongated structural design component for a vehicle body having a portion bendable when a collision load is applied in a longitudinal direction of the component, said portion having an initial closed cross-section essentially orthogonal to said longitudinal direction, said component comprising means arranged to, during the initial stages of bending, essentially maintain the initial cross-section of said portion, wherein said component further comprise means arranged to, during the initial stages of bending, induce local buckling at multiple distributed locations along a delimiting wall of said structural design component arranged to, upon bending, being subject to negative pushing stresses.

2. A structural design component according to claim 1, wherein
said means for maintaining the initial cross-section and said means for inducing local buckling are part of a longitudinally extending deformation control element arranged within said component, which deformation control element is continuous throughout said portion.

3. A structural design component according to claims 1 or 2, wherein
said means for maintaining the initial cross-section comprise at least two longitudinally spaced apart sheet members arranged within said structural design component essentially orthogonal to said longitudinal direction and essentially filling out the initial closed cross-section.

4. A structural design component according to claim 3, wherein
said sheet members are spaced apart by essentially longitudinally extending spacing sections of low bending stiffness.

5. A structural design component according to claim 4, wherein
each of said spacing sections are arranged along an inner delimiting wall of said structural design component and interconnect two of said sheet members.

6. A structural design component according to claim 5, wherein
said spacing sections alternatingly are arranged along opposing inner delimiting walls of said structural design component.

7. A structural design component according to claim 2, wherein
said means for inducing local buckling comprise longitudinally spaced apart interconnections between said deformation control element and said delimiting wall of said structural design component arranged to, upon bending, being subject to negative pushing stresses.

8. A structural design component according to claim 3, wherein
said means for inducing local buckling comprise longitudinally spaced apart interconnections between at least two of said sheet members and said delimiting wall of said structural design component arranged to, upon bending, being subject to negative pushing stresses.

9. A structural design component according to claims 4, 5 or 6, wherein
said means for inducing local buckling comprise longitudinally spaced apart interconnections between at least two of said sheet members and said delimiting wall of said structural design component arranged to, upon bending, being subject to negative pushing stresses.

10. A structural design component according to claims 4, 5 or 6, wherein
said means for inducing local buckling comprise longitudinally spaced apart interconnections between at least two of said spacing sections and said delimiting wall of said structural design component arranged to, upon bending, being subject to negative pushing stresses.

11. A structural design component according to any one of the preceding claims, wherein
said structural design component is a sheet metal component and said means for maintaining the initial cross-section and said means for inducing local buckling comprise sheet metal members.

12. A structural design component according to any one of the preceding claims, wherein
said structural design component is arranged in a structural frame of a vehicle body.

13. A structural design component according to any one of claims 1-11, wherein
said structural design component is arranged in a vehicle.
